(19) United States
(12) Patent Application Publication
(10) Pub. No.: US 2024/0079768 A1
(43) Pub. Date: Mar. 7, 2024

(54) SWITCHING ANTENNA FOR UWB COMMUNICATION FOR VEHICLE

(71) Applicants: HYUNDAI MOBIS CO., LTD., Seoul (KR); UIF (University Industry Foundation), Yonsei University, Seoul (KR)

(72) Inventors: Yoon Jin LEE, Yongin-si (KR); Young Joong YOON, Seoul (KR); Seung Gook CHA, Seoul (KR)

(73) Assignees: HYUNDAI MOBIS CO., LTD., Seoul (KR); UIF (University Industry Foundation), Yonsei University, Seoul (KR)

(21) Appl. No.: 18/240,838

(22) Filed: Aug. 31, 2023

(30) Foreign Application Priority Data
Sep. 2, 2022 (KR) 10-2022-0111351

(51) Int. Cl. H01Q 1/50; G01S 11/02; H01Q 1/38; H01Q 1/48; H01Q 5/25

(52) U.S. Cl. CPC H01Q 1/50; G01S 11/02; H01Q 1/38; H01Q 1/48; H01Q 5/25

(57) ABSTRACT

The present disclosure relates to a switching antenna for UWB communication for a vehicle. The switching antenna may include a substrate part, a radiation part formed in the substrate part and configured to radiate an omnidirectional pattern signal, a main ground part formed in the substrate part and disposed below the radiation part, side ground parts formed on the substrate part and disposed on both sides of the radiation part, and a selection signal part formed in the substrate part and configured to induce a radiation pattern of the radiation part to become either directional or omnidirectional by selectively connecting the main ground part and the side ground part.

### CROSS-REFERENCE TO RELATED APPLICATION

This application claims priority from and the benefit of Korean Patent Application No. 10-2022-0111351, filed on Sep. 2, 2022, which is hereby incorporated by reference for all purposes as if set forth herein.

### BACKGROUND

### Field

Exemplary embodiments of the present disclosure relate to a switching antenna for ultra wide band (UWB) communication for a vehicle, and more particularly, to a switching antenna for UWB communication for a vehicle, which is capable of positioning or the detection of a passenger in the back seat of a vehicle by using signals that are selectively radiated by a directional antenna and an omnidirectional antenna.

### Discussion of the Background

In general, an ultra wide band (UWB) antenna means an antenna for short-distance wireless communication, which can transmit and receive data by wirelessly accessing a peripheral device in a limited space, such as an office, a home, or a vehicle.

The UWB antenna is a short-distance wireless communication device which has a very low frequency band compared to a frequency band of a common antenna device and realizes ultrahigh speed communication with low energy. The UWB antenna can transmit data up to several hundreds of Mbps to several Gbps within a radius of 10 m.

The UWB antenna transmits a signal by distributing energy of the signal to several GHz frequency bands in order to prevent interference with another communication system. The UWB antenna can perform communication without interfering with another narrow band signal and being greatly limited by a frequency. The UWB antenna is robust against noise, and has a high data transfer rate and low power consumption.

The antenna of a UWB module that is used for positioning in a vehicle is omnidirectional, whereas the antenna of a UWB module having a UWB radar function for detecting a passenger in the back seat of a vehicle is directional.

However, there is a problem in that the antennas of the two UWB modules are individually manufactured and used because an omnidirectional antenna and a directional antenna have different characteristics. Accordingly, there is a need to improve such a problem.

The Background technology of the present disclosure is disclosed in Korean Patent Application Publication No. 2021-0039941 (published on Apr. 21, 2021 and entitled “OMNIDIRECTIONAL ULTRA WIDE BAND ANTENNA DEVICE”).

### SUMMARY

Various embodiments are directed to a switching antenna for UWB communication for a vehicle, which is capable of positioning or the detection of a passenger in the back seat of a vehicle by using signals that are selectively radiated by a directional antenna and an omnidirectional antenna.

In an embodiment, a switching antenna for ultra wide band (UWB) communication for a vehicle may include a substrate part, a radiation part on the substrate part and configured to radiate an omnidirectional pattern signal, a main ground part in the substrate part and disposed below the radiation part, a side ground part on the substrate part and disposed on both sides of the radiation part, and a selection signal part in the substrate part and configured to induce a radiation pattern of the radiation part to become either directional and omnidirectional by selectively connecting the main ground part and the side ground part.

The radiation part may be configured to form a pattern on a top surface of the substrate part.

The radiation part may include a radiation feeding part extending from an end of the substrate part and on one side of the substrate part to a center of the substrate part and configured to apply power, and a radiation antenna part connected to the radiation feeding part and configured to radiate an omnidirectional signal in response to an electrical signal from the radiation feeding part.

The substrate part may include a circuit, and the radiation feeding part may have a pole shape, and may be connected to the circuit.

The radiation antenna part may include a first radiation part connected to the radiation feeding part and having a circle shape and a pair of second radiation parts that are symmetrical to each other at an edge of the first radiation part.

The main ground part may be on a back surface of the substrate part and disposed below the radiation part, and may be configured to block a radiation signal of the radiation part.

The main ground part may include a first main ground part on an other side of the substrate part and extends up to ends of the substrate part on both sides of the substrate part, and a second main ground part above the first main ground part and having a concave shape so that the second main ground part does not interfere with the radiation antenna part.

The first main ground part may extend along a longer edge of the substrate part. The top of the first main ground part may be higher than the radiation feeding part and lower than a central point of the radiation antenna part.

The main ground part may include a first main ground part on a side of the substrate part, a second main ground part above the first main ground part and having a concave shape so that the second main ground part does not interfere with the radiation part, a third main ground part on the side of the substrate part and disposed at a first edge of the substrate part, and a fourth main ground part on the side of the substrate part and disposed at a second edge of the substrate part, where the first and second edges may oppose each other.

The first main ground part may extend along a longer edge of the substrate part. Both ends of the first main ground part may be spaced apart from the first and second edges of the substrate part on both sides of the substrate part.

The top of the first main ground part may be higher than the radiation feeding part and lower than a central point of the radiation part.

The third main ground part may include a third vertical ground part extending along the first edge of the substrate part and a third horizontal ground part extending laterally from the third vertical ground part.

The third main ground part may be spaced apart from or connected to the first main ground part.

The fourth main ground part may include a fourth vertical ground part extending along the second edge of the substrate part, and a fourth horizontal ground part extending laterally from the fourth vertical ground part.

The fourth main ground part may be spaced apart from or connected to the first main ground part.

The side ground part may be on a back surface of the substrate part and may be configured to block a radiation signal of the radiation part by covering both sides of the radiation part.

The side ground part may extend along two opposing shorter edges of the substrate part.

The selection signal part may include a signal pattern part configured to connect the main ground part and the side ground part, and a signal application part connected to the signal pattern part and configured to apply power to the signal pattern part.

When the selection signal part connects the main ground part and the side ground part, a radiation signal of the radiation part becomes directional.

When the selection signal part blocks a connection between the main ground part and the side ground part, a radiation signal of the radiation part becomes omnidirectional.

In the switching antenna for UWB communication for a vehicle according to an embodiment of the present disclosure, the main ground part is formed under the radiation part that provides an omnidirectional radiation signal, and the side ground parts are formed on both sides of the radiation part. Furthermore, the main ground part and the side ground parts can provide an omnidirectional radiation signal or a directional radiation signal by being selectively connected or separated from each other by the selection signal part.

### BRIEF DESCRIPTION OF THE DRAWINGS

FIG. 1 is a diagram schematically illustrating a switching antenna for UWB communication for a vehicle according to an embodiment of the present disclosure.

FIG. 2 is a diagram schematically illustrating a radiation part according to an embodiment of the present disclosure.

FIG. 3 is a diagram schematically illustrating a main ground part according to a first embodiment of the present disclosure.

FIG. 4 is a diagram schematically illustrating the main ground part according to a second embodiment of the present disclosure.

FIG. 5 is a diagram schematically illustrating the state in which the switching antenna for UWB communication for a vehicle, including the main ground part according to the first embodiment of the present disclosure, provides a directional radiation signal.

FIG. 6 is a diagram schematically illustrating the state in which the switching antenna for UWB communication for a vehicle, including the main ground part according to the second embodiment of the present disclosure, provides a directional radiation signal.

FIG. 7 is a diagram schematically illustrating the state in which the switching antenna for UWB communication for a vehicle, including the main ground part according to the first embodiment of the present disclosure, provides an omnidirectional radiation signal.

FIG. 8 is a diagram schematically illustrating the state in which the switching antenna for UWB communication for a vehicle, including the main ground part according to the second embodiment of the present disclosure, provides an omnidirectional radiation signal.

### DETAILED DESCRIPTION OF THE ILLUSTRATED EMBODIMENTS

Hereinafter, a switching antenna for ultra wide band (UWB) communication for a vehicle will be described below with reference to the accompanying drawings through various exemplary embodiments. In this process, the thicknesses of lines or the sizes of components illustrated in the drawings may have been exaggerated for the clarity of a description and for convenience' sake. Furthermore, terms to be described below have been defined by taking into consideration their functions in the present disclosure, and may be changed depending on a user or operator's intention or practice. Accordingly, such terms should be defined based on the overall contents of this specification.

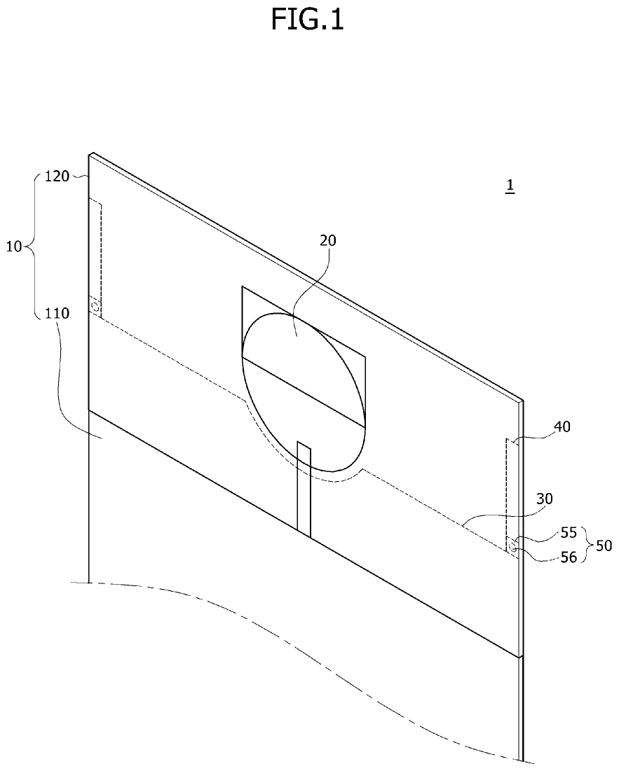

FIG. 1 is a diagram schematically illustrating a switching antenna for UWB communication for a vehicle according to an embodiment of the present disclosure. Referring to FIG. 1, the switching antenna 1 for UWB communication for a vehicle according to an embodiment of the present disclosure may include a substrate part 10, a radiation part 20, a main ground part 30, a side ground parts 40, and a selection signal part 50.

The substrate part 10 is fabricated by using a resin material. A part of the plane of the substrate part 10 may be partitioned into a substrate circuit part 110 in which a circuit is embedded and a substrate antenna part 120 in which an antenna is formed. A plurality of such substrate parts 10 may form a layer and may be bonded or may be molded through a mold. In addition, a pattern antenna may be formed on one side of the substrate part 10. A circuit may be formed on the other side of the substrate part 10.

The radiation part 20 may be formed on the substrate part 10, and may radiate an omnidirectional pattern signal. For example, the radiation part 20 may form a pattern on the top of the substrate part 10. The radiation part 20 may be connected to the substrate circuit part 110, and may be disposed in the substrate antenna part 120.

The main ground part 30 may be formed on the substrate part 10, and may be disposed below the radiation part 20. For example, the main ground part 30 may be formed on a back surface of the substrate part 10, may be disposed below the radiation part 20, and may block a radiation signal of the radiation part 20.

The side ground part 40 may be formed on the substrate part 10, and may be disposed on both sides of the radiation part 20. For example, the side ground parts 40 may be formed on the back surface of the substrate part 10, and may block the radiation signal of the radiation part 20 by covering the left side of the radiation part 20 and the right side of the radiation part 20. The side ground parts 40 may be formed to have lengths in the vertical direction at edges of the substrate part 10 on the left and right sides thereof, respectively.

The selection signal part 50 is formed in the substrate part 10, and selectively connects the main ground part 30 and the side ground parts 40 so that the radiation pattern of the radiation part 20 is induced to become either directional or omnidirectional.

For example, the selection signal part 50 may be formed on the substrate part 10, and may selectively block the radiation signal of the radiation part 20 so that an omnidirectional radiation signal of the radiation part 20 is induced to be radiated or to become a directional radiation signal to be radiated. The selection signal part 50 may include a signal pattern part 55 that is formed on the back surface of the substrate part 10 and that connects the main ground part 30 and the side ground parts 40 and a signal application part 56 that is connected to the signal pattern part 55 and that applies power to the signal pattern part 55. The signal application part 56 may be embedded in the substrate antenna part 120 and connected to the substrate circuit part 110 so that power can be supplied to the signal application part 56. The signal application part 56 may be a pin diode that is embedded in the substrate part 10. A wire for control of the pin diode may be disposed in third and fourth layers of the substrate part 10. If the wire passes through another layer of the substrate part 10, a via hole may be formed in the another layer.

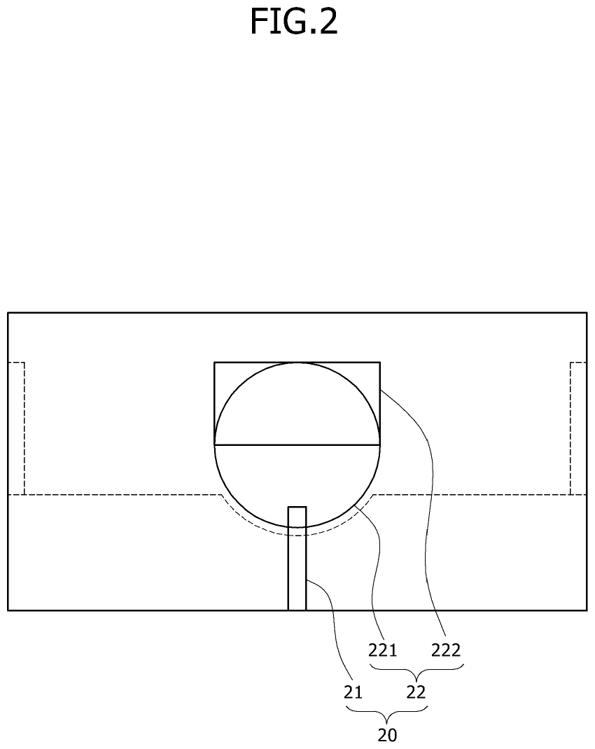

FIG. 2 is a diagram schematically illustrating the radiation part according to an embodiment of the present disclosure. Referring to FIG. 2, the radiation part 20 according to an embodiment of the present disclosure may include a radiation feeding part 21 and a radiation antenna part 22.

The radiation feeding part 21 may extend from an end of the substrate part 10 on one side thereof to the center thereof, and may apply power. For example, the radiation feeding part 21 may be formed at the top of the substrate part 10, may have a pole shape, and may extend from the bottom of the substrate antenna part 120 to the center of the substrate antenna part 120. The radiation feeding part 21 may be connected to the circuit of the substrate circuit part 110, and may apply power to the circuit.

The radiation antenna part 22 may be connected to the radiation feeding part 21, and may radiate an omnidirectional signal in response to an electrical signal from the radiation feeding part 21. For example, the radiation antenna part 22 may include a first radiation part 221 that is connected to the radiation feeding part 21 and that has a circle shape and a pair of second radiation parts 222 that are formed at an edge of the first radiation part 221 so that the pair of second radiation parts 222 are symmetrical to each other and that form a peak.

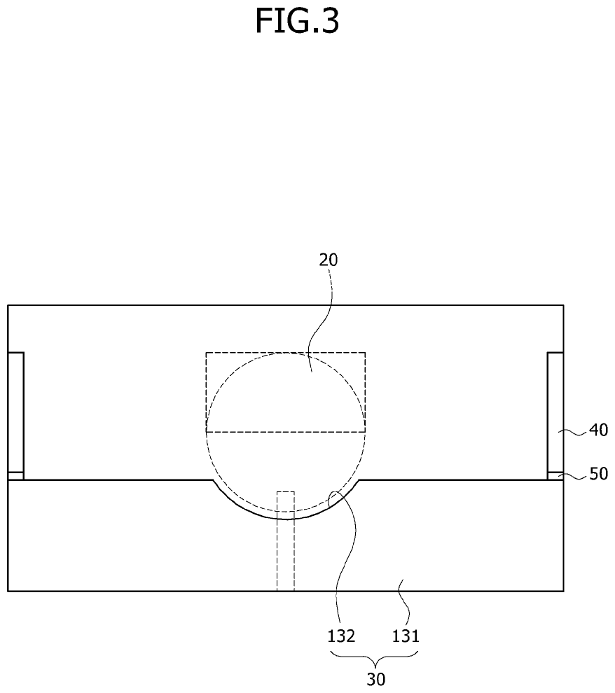

FIG. 3 is a diagram schematically illustrating the main ground part according to a first embodiment of the present disclosure. Referring to FIG. 3, the main ground part 30 according to the first embodiment of the present disclosure may include a first main ground part 131 and a second main ground part 132.

The first main ground part 131 may be formed on the other side of the substrate part 10, and may extend up to ends of the substrate part 10 on both sides thereof. For example, the first main ground part 131 may be formed on the back surface of the substrate part 10, and may be formed to have a length in a horizontal direction of the substrate part 10. Both ends of the first main ground part 131 may extend up to left and right edges of the substrate part 10 on both sides thereof. The top of the first main ground part 131 may be disposed to have a higher point than the radiation feeding part 21 and to have a lower point than the central point of the radiation antenna part 22.

The second main ground part 132 may be formed at the top of the first main ground part 131, and may have a concave shape so that the second main ground part 132 does not interfere with the radiation antenna part 22. For example, the second main ground part 132 may have a round shape in a central part of the first main ground part 131 at the top thereof.

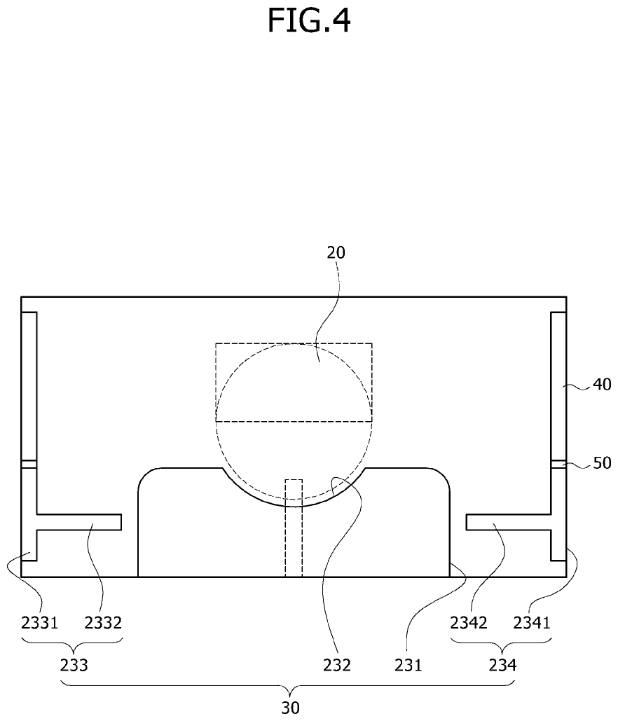

FIG. 4 is a diagram schematically illustrating the main ground part according to a second embodiment of the present disclosure. Referring to FIG. 4, the main ground part 30 according to the second embodiment of the present disclosure may include a first main ground part 231, a second main ground part 232, a third main ground part 233, and a fourth main ground part 234.

The first main ground part 231 may be formed on the other side of the substrate part 10. For example, the first main ground part 231 may be formed on the back surface of the substrate part 10, and may be formed to have a length in the horizontal direction of the substrate part 10. Both ends of the first main ground part 231 may be spaced apart from each other at the left and right edges of the substrate part 10 on both sides thereof. The top of the first main ground part 131 may be disposed to have a higher point than the radiation feeding part 21 and to have a lower point than the central point of the radiation antenna part 22.

The second main ground part 232 is formed at the top of the first main ground part 231, and has a concave shape so that the second main ground part 232 does not interfere with the radiation antenna part 22. For example, the second main ground part 232 may have a round shape in a central part of the first main ground part 231 at the top thereof.

The third main ground part 233 may be formed in the other side of the substrate part 10, and may be disposed at the edge of the substrate part 10 on the left side thereof. For example, the third main ground part 233 may include a third vertical ground part 2331 that is formed in the back surface of the substrate part 10 and that has a length in the vertical direction at the edge of the substrate part 10 on the left side thereof and a third horizontal ground part 2332 that extends laterally from the third vertical ground part 2331. The third horizontal ground part 2332 may be spaced apart from a left end of the first main ground part 231 or may be connected thereto.

The fourth main ground part 234 is formed in the other side of the substrate part 10, and is disposed at the edge of the substrate part 10 on the right side thereof. For example, the fourth main ground part 234 may include a fourth vertical ground part 2341 that is formed in the back surface of the substrate part 10 and that has a length in the vertical direction at the edge of the substrate part 10 on the right side thereof and a fourth horizontal ground part 2342 that extends laterally from the fourth vertical ground part 2341. The fourth horizontal ground part 2342 may be spaced apart from a right end of the first main ground part 231 or may be connected thereto.

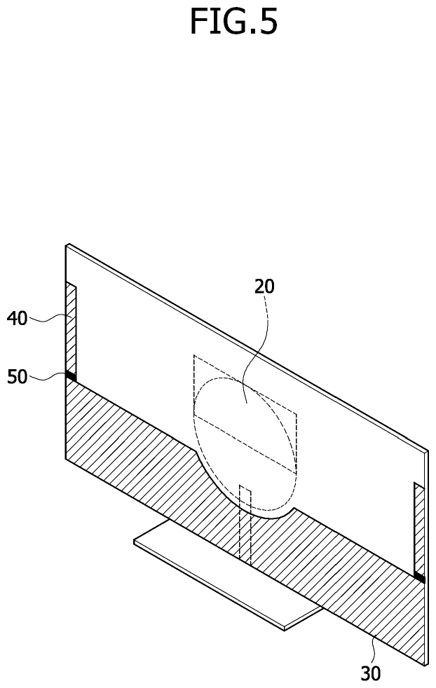

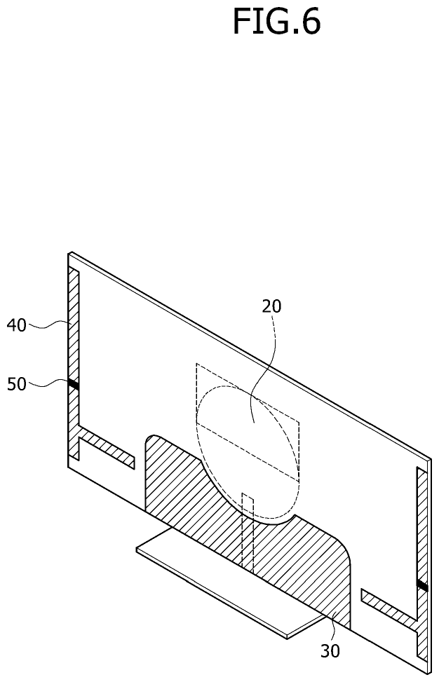

FIG. 5 is a diagram schematically illustrating the state in which the switching antenna for UWB communication for a vehicle, including the main ground part according to the first embodiment of the present disclosure, provides a directional radiation signal. FIG. 6 is a diagram schematically illustrating the state in which the switching antenna for UWB communication for a vehicle, including the main ground part according to the second embodiment of the present disclosure, provides a directional radiation signal. Referring to FIGS. 5 and 6, when the selection signal part 50 connects the main ground part 30 and the side ground parts 40, a radiation signal of the radiation part 20 becomes directional.

For example, when power is applied to the selection signal part 50 and the main ground part 30 and the side ground part 40 become the state in which the main ground part 30 and the side ground part 40 have been connected, a radiation signal that is generated by the radiation part 20 may be radiated only upward from the radiation part 20, and may provide a directional signal.

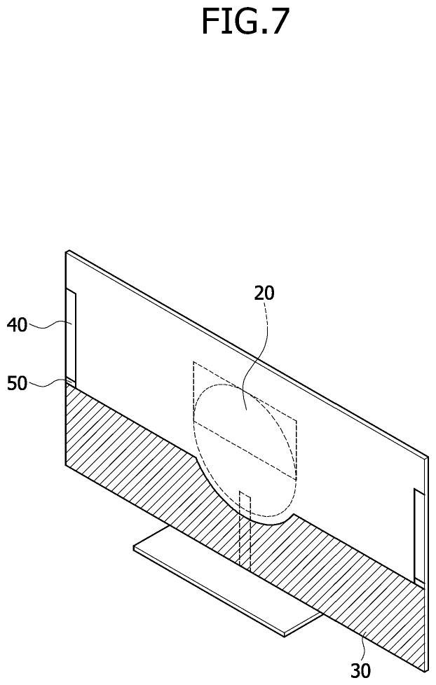

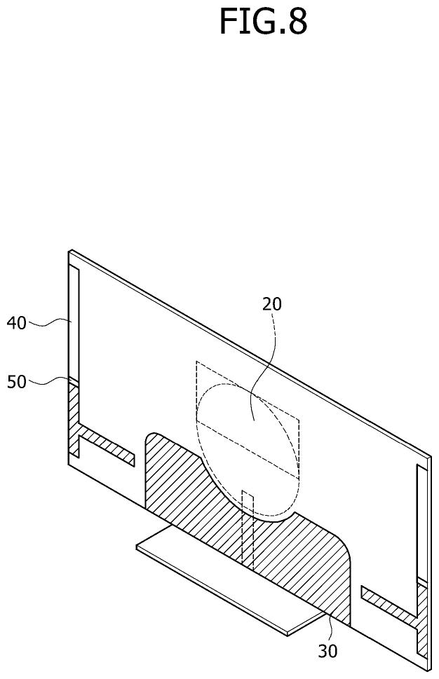

FIG. 7 is a diagram schematically illustrating the state in which the switching antenna for UWB communication for a vehicle, including the main ground part according to the first embodiment of the present disclosure, provides an omnidirectional radiation signal. FIG. 8 is a diagram schematically illustrating the state in which the switching antenna for UWB communication for a vehicle, including the main ground part according to the second embodiment of the present disclosure, provides an omnidirectional radiation signal. Referring to FIGS. 7 and 8, if the selection signal part 50 blocks a connection between the main ground part 30 and the side ground parts 30, a radiation signal of the radiation part 20 becomes omnidirectional.

For example, if power is not applied to the selection signal part 50, the main ground part 30 and the side ground part 40 become the state in which the main ground part 30 and the side ground part 40 have been separated from each other, a radiation signal that is generated by the radiation part 20 may be radiated upward and laterally from the radiation part 20, and may provide an omnidirectional signal.

An operation of the switching antenna 1 for UWB communication for a vehicle having such a structure is described as follows.

The radiation part 20 is formed at the central part of the substrate part 10 at the top thereof. The main ground part 30 is formed at a lower part of the substrate part 10 at the back surface thereof. The side ground parts 40 are formed at the edges of the substrate part 10 on both sides thereof at the back surface of the substrate part 10. In this case, the main ground part 30 and the side ground part 40 are connected by the selection signal part 50.

If the detection of a passenger in the back seat of a vehicle is required in this state, when power is applied to the selection signal part 50, the main ground part 30 and the side ground parts 40 becomes the state in which the main ground part 30 and the side ground parts 40 have been connected. Accordingly, a radiation signal that is radiated by the radiation part 20 becomes a directional radiation signal by the main ground part 30 and the side ground part 40, so that whether a passenger has sat in the back seat of a vehicle can be detected.

If positioning is required, when the supply of power to the selection signal part 50 is blocked, the main ground part 30 and the side ground parts 40 become the state in which the main ground part 30 and the side ground parts 40 have been separated from each other. Accordingly, positioning can be possible by an omnidirectional radiation signal that is radiated by the radiation part 20.

In the switching antenna 1 for UWB communication for a vehicle according to an embodiment of the present disclosure, the main ground part 30 is formed below the radiation part 20 that provides an omnidirectional radiation signal. The side ground parts 40 are formed on both sides of the radiation part 20. The main ground part 30 and the side ground part 40 are selectively connected or separated from each other by the selection signal part 50. Accordingly, an omnidirectional radiation signal or a directional radiation signal can be provided.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A switching antenna for ultra wide band (UWB) communication for a vehicle, the switching antenna comprising:
a substrate part;
a radiation part on the substrate part and configured to radiate an omnidirectional pattern signal;
a main ground part on the substrate part and disposed below the radiation part;
a side ground part in the substrate part and disposed on both sides of the radiation part; and
a selection signal part on the substrate part and configured to induce a radiation pattern of the radiation part to become either directional or omnidirectional by selectively connecting the main ground part and the side ground part.

2. The switching antenna of claim 1, wherein the radiation part is configured to form a pattern on a top surface of the substrate part.

3. The switching antenna of claim 1, wherein the radiation part comprises:
a radiation feeding part extends from an end of the substrate part and on one side of the substrate part to a center of the substrate part and configured to apply power; and
a radiation antenna part connected to the radiation feeding part and configured to radiate an omnidirectional signal in response to an electrical signal from the radiation feeding part.

4. The switching antenna of claim 3, wherein the substrate part includes a circuit, and
wherein the radiation feeding part has a pole shape, and is connected to the circuit.

5. The switching antenna of claim 3, wherein the radiation antenna part comprises:
a first radiation part connected to the radiation feeding part and having a circle shape; and
a pair of second radiation parts that is symmetrical to each other at an edge of the first radiation part.

6. The switching antenna of claim 1, wherein the main ground part is on a back surface of the substrate part and disposed below the radiation part, and is configured to block a radiation signal of the radiation part.

7. The switching antenna of claim 3, wherein the main ground part comprises:
a first main ground part on an other side of the substrate part and extends up to ends of the substrate part on both sides of the substrate part; and
a second main ground part above the first main ground part and having a concave shape so that the second main ground part does not interfere with the radiation antenna part.

8. The switching antenna of claim 7, wherein:
the first main ground part extends along a longer edge of the substrate part, and
a top of the first main ground part is higher than the radiation feeding part and lower than a central point of the radiation antenna part.

9. The switching antenna of claim 2, wherein the main ground part comprises:
a first main ground part on a side of the substrate part;
a second main ground part above the first main ground part and having a concave shape so that the second main ground part does not interfere with the radiation part;
a third main ground part on the side of the substrate part and disposed at a first edge of the substrate part; and
a fourth main ground part on the side of the substrate part and disposed at a second edge of the substrate part, where the first and second edges oppose each other.

10. The switching antenna of claim 9, wherein:
the first main ground part extends along a longer edge of the substrate part, and
both ends of the first main ground part are spaced apart from the first and second edges of the substrate part on both sides of the substrate part.

11. The switching antenna of claim 10, wherein a top of the first main ground part is higher than the radiation feeding part and lower than a central point of the radiation part.

12. The switching antenna of claim 9, wherein the third main ground part comprises:
a third vertical ground part extends along the first edge of the substrate part; and
a third horizontal ground part extending laterally from the third vertical ground part.

13. The switching antenna of claim 12, wherein the third main ground part is spaced apart from or connected to the first main ground part.

14. The switching antenna of claim 9, wherein the fourth main ground part comprises:
a fourth vertical ground part extends along the second edge of the substrate part; and
a fourth horizontal ground part extending laterally from the fourth vertical ground part.

15. The switching antenna of claim 14, wherein the fourth main ground part is spaced apart from or connected to the first main ground part.

16. The switching antenna of claim 1, wherein the side ground part is on a back surface of the substrate part and configured to block a radiation signal of the radiation part by covering both sides of the radiation part.

17. The switching antenna of claim 1, wherein the side ground part extends along two opposing shorter edges of the substrate part.

18. The switching antenna of claim 1, wherein the selection signal part comprises:
a signal pattern part configured to connect the main ground part and the side ground part; and
a signal application part connected to the signal pattern part and configured to apply power to the signal pattern part.

19. The switching antenna of claim 1, wherein when the selection signal part connects the main ground part and the side ground part, a radiation signal of the radiation part becomes directional.

20. The switching antenna of claim 1, wherein when the selection signal part blocks a connection between the main ground part and the side ground part, a radiation signal of the radiation part becomes omnidirectional.
